(19) United States
(12) Patent Application Publication
(10) Pub. No.: US 2023/0390931 A1
(43) Pub. Date: Dec. 7, 2023

(54) LONG-TERM STORAGE OF A ROBOT CONTAINING A BATTERY, ROBOT CONFIGURATION AND METHOD OF OPERATING THE ROBOT

(71) Applicant: BSH Hausgeräte GmbH, 81739 (DE)

(72) Inventors: Markus Moelter, Hollstadt (DE); Frank Schnitzer, Bad Neustadt (DE); Jürgen Mack, Göppingen (DE)

(21) Appl. No.: 18/330,518

(22) Filed: Jun. 7, 2023

(30) Foreign Application Priority Data
Jun. 7, 2022 (DE) 10 2022 205 782.1

(51) Int. Cl. B25J 9/16; B25J 19/00

(52) U.S. Cl. CPC B25J 9/1674; B25J 19/0025

(57) ABSTRACT

A robot contains a battery module which has a battery and a battery manager managing the battery. The battery manager is configured to set the battery module into a deep sleep mode upon receiving a sleep signal and to terminate the deep sleep mode upon receiving a wake-up signal. The robot is configured to generate the wake-up signal without the use of energy from the battery. A robot arrangement contains the robot and a charging station for the robot which has a counter-interface for providing the electrical energy. The robot can be coupled to the charging station such that the interface can be supplied with the electrical energy from the counter-interface. In a method for operating a robot or the robot arrangement, the wake-up signal is generated without the use of energy from the battery.

### CROSS-REFERENCE TO RELATED APPLICATION

This application claims the priority, under 35 U.S.C. § 119, of German patent application DE 10 2022 205 782.1, filed Jun. 7, 2022; the prior application is herewith incorporated by reference in its entirety.

### FIELD AND BACKGROUND OF THE INVENTION

The invention relates to a robot containing a battery module. The battery module contains a battery and a battery manager for monitoring or managing the battery. In particular, household robots, for example autonomous vacuuming and/or mopping or mowing robots are considered as the robots here. A drawback in this case is the self-discharge of the battery module over lengthy periods of non-use of the robot. A relatively significant discharge takes place, since such battery managers fulfill complex monitoring tasks on the battery and thus have a relatively high individual requirement for electrical energy which has to be met by the battery.

Thus, for example, a battery can already be fully discharged when a newly produced robot reaches the end customer after a lengthy storage time at the manufacturer/distributor. In the worst case, the battery is significantly discharged and as a result, the battery module is damaged.

A battery pack for a vacuum cleaner is disclosed in European patent application EP 3 440 974 A1, having a battery management system (BMS) and a wake-up circuit with an acceleration sensor. The battery management system (BMS) has at least one operating mode in which battery power is provided for the vacuum cleaner and a sleep mode in which no battery power is provided for the vacuum cleaner, and the wake-up circuit is configured to switch the battery management system (BMS) from sleep mode to operating mode on the basis of a first acceleration pattern detected by the acceleration sensor.

A vacuum cleaner is disclosed in published, non-prosecuted German patent application DE 10 2019 108 571 A1, and contains a storage battery or a rechargeable battery which is configured for supplying energy to the vacuum cleaner and which has a battery management system which is configured for monitoring and controlling or regulating the battery, an acceleration sensor, a state of charge display which is configured to display a state of charge of the battery, at least one communication line which is configured to communicate the state of charge from the battery to the state of charge display, and an appliance electronics system which is configured, when the acceleration sensor detects no movement and/or when the battery is fully charged up, and after the elapse of a predetermined time period in which it is detected that there is no movement and/or that the battery is fully charged up, to set the battery into a sleep mode in which the state of charge display is switched off, and when the acceleration sensor detects a movement, to set the battery into a wake-up mode in which the state of charge display is switched on and displays a state of charge communicated from the battery management system via the at least one communication line.

A wireless battery operated system for cleaning products is disclosed in international patent disclosure WO 2010/045 588 A1, corresponding to U.S. Pat. Nos. 10,568,481, 9,504,364, 9,461,282, 8,756,753, 8,671,509, and 8,607,405. The system of cleaning products contains appliances such as for example upright vacuum cleaners (for example a stick vacuum cleaner, a lightweight upright vacuum cleaner, etc.), a hand-held vacuum cleaner, a carpet cleaner, a canister vacuum cleaner and the like. Each of the appliances is powered by a battery pack, which is interchangeable between the appliances. The battery pack contains a combination of hardware and software for connecting to, identifying and communicating with the cleaning products in order to ensure that each of the products obtains the energy, which is required for optimal performance.

### SUMMARY OF THE INVENTION

It is the object of the present invention to propose improvements relative to the robots under discussion.

The object is achieved by a robot having the feature of the independent robot claim. Preferred or advantageous embodiments of the invention and other categories of invention are found in the further claims, the following description and the accompanying figures. The robot, in particular, is a household robot, for example an autonomous vacuuming and/or mopping or mowing robot.

The robot contains a battery module. The battery module serves for supplying the robot with electrical energy; in this regard it is an autonomous robot, which can operate without an external energy supply. The battery module contains a rechargeable battery, i.e. a storage battery or comparable energy storage device. The battery module contains a battery manager, which serves or is configured to manage the battery. Such a battery manager is also called a “battery management system (BMS)”. The battery manager thus serves for monitoring the battery cells, in particular the current, voltage and temperature thereof. The battery manager also serves for the maintenance, the charging/discharging management of the battery cells, etc.

The battery manager is a so-called deep sleep-capable battery manager, which is configured to set the battery module into a deep sleep mode upon receiving a sleep signal. The battery manager is also configured to terminate the deep sleep mode upon receiving a wake-up signal.

The robot is designed to generate the wake-up signal without the use of energy from the battery. “Without energy from the battery” means that this is not to be understood to be an actual wake-up routine within the battery manager. In fact, this wake-up routine is generally powered by the battery. However, this means a wake-up signal or a wake-up pulse, which is supplied from outside the battery manager or the battery module. In this case, this wake-up signal is solely generated from outside the battery.

The wake-up signal, in particular, is a connection of a specific wake-up line on the battery module, for example by applying current or voltage to this wake-up line, optionally also connecting an input on the battery module/battery manager to ground, wherein this is also carried out such that energy is not taken from the battery. The wake-up signal can also be generated simply by current or voltage being applied to the battery module or a power input of the battery module, which serves for the regular charging up of the battery with electrical energy. The battery manager then detects the corresponding application of the (charging) voltage or the flow of (charging) current and immediately leaves the deep sleep state. The signal pulse/the energy thereof for the wake-up signal is thus implemented from outside, without taking energy from the battery for this purpose.

The energy for generating the wake-up signal originates, in particular, from an auxiliary battery which is different from the battery, for example from an additional circuit of the robot which contains the extra auxiliary battery, i.e. different from the battery, for example an AA battery, D battery, 9V block battery. The auxiliary battery is, for example, a lithium-ion storage battery in a display/display module of the robot, and the activation energy for the wake-up signal is then taken from the auxiliary battery.

Alternatively, a branch circuit of the auxiliary battery is provided, the branch circuit being activated, for example, via a control element (for example a user interface, see below) and delivering a small charging current to the battery module which then wakes up as a result. In this case, the wake-up signal is the supply of charging energy to the battery module; accordingly see below the supply from the interface/coupling to the charging station/base station.

These are alternative methods for waking up the battery module for coupling/positioning the robot onto a charging station/base station (coupling the interface to the counter-interface, see below).

According to the invention, it is achieved that no electrical energy has to be made available by the battery to outside the battery module, in order to terminate the deep sleep mode or to provide a termination functionality. Thus no accidental flows of current, leakages of current or the like can be produced in this way, which could lead to an inadvertent/relatively rapid discharging of the battery.

In a preferred embodiment, the robot contains an input module. The input module can be controlled by a user. The robot is configured to generate the sleep signal when a sleep input is made on the input module. The sleep input can be activated by the user, i.e. can be executed thereby, and thus represents a control, initiation, activation on the input module, i.e. the generation of a sleep command. In particular, the sleep input is actually made by the user deliberately operating the input module. In other words, the user activates the sleep input by operating the input module, and whereupon the sleep signal is generated in the robot, whereby the battery module is set into deep sleep mode. It is conceivable that the sleep input is generated inadvertently by the user or in a different manner, but this is prevented as far as possible by suitable measures, see below.

In a preferred variant of this embodiment, the input module contains at least one control element. The control element can be actuated by a user or the above-mentioned user, in particular manually. An actual actuation of the control element is thus at least one component of the sleep input. “Component” is to be understood to mean that further actions are necessary/conditions have to be fulfilled in order to constitute a full sleep input, for example receiving a radio signal from outside the robot, see below. In particular, however, the sleep input is fully implemented by actuating the control element.

In other words, an actuation/activation/operation, in particular a manual or hand operation, of the control element is required in order to implement the sleep input. The sleep signal is generated either by the control element itself and/or by a controller of the robot assigned to the control element and communicated to the battery module. Thus, a sleep signal is not generated without actuating the control element.

In a preferred variant of this embodiment, the input module contains at least two control elements. An actuation of a plurality of control elements according to a specific control pattern is at least one component of the sleep input or forms the sleep input, as already correspondingly explained above. In other words, a plurality of control elements have to be actuated according to a specific control pattern in order to implement the sleep input. An inadvertent actuation of a single control element is thus excluded. A corresponding control pattern is, for example, the actuation of two control elements at the same time and/or the actuation of different control elements in a specific sequence within a specific allotted time, etc. The more complex the control pattern, the less likely a sleep input is inadvertently input.

The control element/control elements has/have, in particular, the functionality of the sleep input only as a separate function. The control elements regularly have different types of control functionality on the robot, for example setting a suction strength, coupling to a base station, activating audible signals on the robot, etc. which is not to be explained here in more detail.

In particular, as already accordingly explained above, the input module cooperates with a controller, which recognizes and evaluates a corresponding control pattern and converts the corresponding sleep input into a sleep signal or enables this sleep signal. Alternatively, the input module can itself undertake a corresponding evaluation of the control inputs/monitoring of the control pattern and signal generation.

In a preferred variant of this embodiment, the input module contains a signal receiver. The signal receiver is configured to receive an input signal, which can be generated by the user. The robot is configured to generate the sleep signal when the input signal is received. The receiving of the input signal thus results from at least one component of a sleep input or takes place as a result of a sleep input, which generates or transmits the input signal. In other words, in this case the input signal has to be (transmitted and) received in order to generate the sleep signal and thus to trigger or to start the deep sleep mode in the battery module. An inadvertent generation of a corresponding input signal can generally be prevented particularly effectively since in this case protective measures in terms of signal-technology, etc. can be taken.

In a preferred variant of this embodiment, the signal receiver is a wireless receiver and the input signal is a wireless signal. Corresponding receivers or signals, for example radio-based or infrared-based, are conceivable. Examples thereof are, for example, Wi-Fi, WLAN, Bluetooth, mobile communications, etc.

In a preferred variant of this embodiment, the signal receiver is configured to receive the input signal from a control device. The control device is different from the robot. The control device can be controlled by a user by means of the sleep input or in the form of the sleep input.

Thus, for example, the wireless receiver is designed to communicate with a control device via radio. The input signal is generated, for example, by pressing on a real or virtual “key” of the control device or on the control device. By corresponding safety mechanisms on the control device/transmission path, it can be ensured particularly effectively that an incorrect activation or inadvertent activation of the sleep signal is not made.

In a preferred variant of this embodiment, the control device is a hand-held control device (able to be hand-held by the user). In particular, the control device is a smartphone, a tablet computer, PC, laptop, etc. The input signal is generated, in particular, by an application (for example an “app” on a smartphone) which is executed or which is to be executed on the corresponding control device, which receives the sleep input. In particular, the control device is designed to generate the input signal as a wireless signal. In particular, the control device is designed to generate the input signal by operating a program (application) of the control device. In particular, the program can be controlled by a user. In particular, the coupling of a robot to a corresponding app on a smartphone is common practice nowadays, so that this variant can be implemented in a particularly simple manner.

In a preferred embodiment, the robot contains an electrical interface. The electrical interface is configured to supply the battery module with electrical energy. The electrical energy is provided to the robot from outside the robot on the interface. The electrical interface serves, in particular, for charging the battery module or the battery. The corresponding energy comes from outside the robot. The robot is configured to generate the wake-up signal when the interface is supplied with electrical energy.

According to this embodiment, the need for energy from the battery in order to leave the deep sleep state is particularly effectively avoided, since sufficient energy is provided via the electrical interface in order to generate relevant switching signals on the battery manager, or at least no battery energy is required in order to send the corresponding switching information to the battery module.

In a preferred embodiment, therefore, the electrical energy for generating the wake-up signal (if such a signal is required) is provided, in particular, exclusively from the interface.

In a preferred embodiment, in deep sleep mode the battery manager is configured to carry out simply a monitoring of a voltage and or a temperature of the battery at least at time intervals. Such deep sleep modes are often found in battery managers and are characterized in that only minimal energy has to be taken from the battery in order to be able to carry out the corresponding monitoring, even over a long period of time, without the battery being significantly discharged. A further advantage thereof is that in such deep sleep modes, the power output of the battery module can be limited to a fraction of the rated power of the battery. Even if the battery module is short-circuited by a random error, for example, it is generally possible to avoid large current flows and thus the generation of heat, the start of a fire, etc. Sufficient time is also still available to identify a corresponding error state and to carry out servicing on the robot or the battery module in good time, in order to avoid the battery module ultimately being significantly discharged and thus being damaged.

The object of the invention is also achieved by a robot arrangement according to the independent robot arrangement claim. The robot arrangement contains the robot according to the invention, in the embodiment with an interface as explained above, and a charging station for the robot. As a suitable counterpart to the interface, the charging station has a counter-interface for providing electrical energy. The robot can be coupled to the charging station such that the interface can be supplied with electrical energy from the counter-interface or the charging station is actually supplied with electrical energy during operation.

As a result, it is possible that a wake-up signal is always generated, when the robot is coupled with its interface to the counter-interface, which actually provides electrical energy, or when—with the robot already coupled thereto—the counter-interface starts to provide electrical energy. In particular, the moment of coupling the robot to the charging station/the provision of electrical energy at the counter-interface, and thus at the interface, generates the wake-up signal. This is a particularly simple and intuitive possibility for generating the wake-up signal.

The robot arrangement and at least some of the possible embodiments thereof, and the respective advantages, have already been correspondingly explained in connection with the robot according to the invention.

The object of the invention is also achieved by a method according to the independent method claim for operating the robot according to the invention or the robot arrangement according to the invention. In the method, the wake-up signal is generated without the use of energy from the battery.

The method and at least some of the possible embodiments thereof, and the respective advantages, have already been correspondingly explained in connection with the robot according to the invention and the robot arrangement according to the invention.

In a preferred embodiment of the method, the battery module is set into deep sleep mode after or at the end of a production of the robot in a production facility and before the storage of the robot in the production facility and or before the dispatch of the robot from the production facility. Thus, it is ensured that the energy consumption in the battery module is reduced before and during the storage and/or dispatch of the robot, and thus the risk is reduced of the battery module being significantly discharged and damaged.

In a preferred variant of this embodiment, the battery module is set into deep sleep mode within an end of line test of the robot. This test follows the actual production of the robot or—in an alternative viewpoint-forms the final step of production. Since a corresponding end of line test generally immediately follows the actual production of the robot—also in the sense of a last production step—the setting into deep sleep mode, on the one hand, cannot be omitted and also takes place immediately or directly after or at the end of the production of the robot.

The invention is based on the following findings, observations or considerations and also contains the following preferred embodiments. These embodiments are also called “the invention”, partly for simplification. The embodiments can also contain parts or combinations of the above-mentioned embodiments or can correspond thereto and/or optionally can also include embodiments, which have not been previously mentioned.

A household robot is intended to serve as an example of the robot under discussion; but the following statements generally apply to all of the robots under discussion. The invention is based on the below described observations.

Autonomous cleaning robots automatically clean all of the floor surfaces of a dwelling which can be reached or which are predetermined by a user, and in this manner can relieve the user of significant work. In order to have a range which is as large as possible, and not to be limited by a power supply cable, these robots generally have a battery, in particular a (rechargeable) storage battery, for example a lithium-ion storage battery (Li-ion storage battery). The robot can recharge/fill up this storage battery at its base station, which functions as a charging station and in this regard is independent of the user. Such a storage battery is, for example, screwed into a lower housing of the robot.

The cells of a storage battery pack (battery module) are generally continually subjected to a certain level of self-discharge, so that even without active operation of the robot the state of charge reduces (very) slowly but continually over time. A battery manager, also called a battery management system (BMS), takes up a larger portion of the discharge of the storage battery, compared to the self-discharge, without active operation of the robot, the battery management system-in regular operation-continually carrying out a monitoring of the cells of the battery module and thereby resulting in a slight but still appreciable power consumption. The influence of the BMS also affects the storage period of the storage battery. If the state of charge of the Li-ion storage battery falls below a critical value, the storage battery has to be deactivated (by the BMS), possibly permanently, and can no longer be reactivated. If this occurs before a robot has been sold with this particular storage battery to a customer-after the production or manufacture thereof by a producer/manufacturer—the robot cannot be used and the storage battery has to be replaced. In order to avoid this problem, it is conceivable to recharge the relevant robots during their storage (between manufacture and sale/dispatch to a consumer/end customer), i.e. the robot has to be unpackaged, charged up and packaged up again, so that the storage battery voltages do not drop into the critical range during continued storage.

However, BMS, which can be set into different standby modes in order to reduce consumption, are also known from practice. For long-term storage or transport, a mode in which only the necessary values of the storage battery cells are monitored is sufficient for the consumption to be able to be minimized and thus the storage time to be able to be maximized. However, in such a state the BMS has to be actively set (the deep sleep state has to be terminated) since without intervention from outside a BMS remains in its current state. In this state, which is called deep sleep, the storage battery cannot be used.

A robot is generally monitored for correct functioning at the end of its production and after assembly, and so-called end of line tests are carried out to this end. For this test step, the storage battery has already been inserted into the robot and supplies the robot with voltage or energy during the test procedures. If the storage battery or the BMS was previously in a low consumption state (deep sleep, generally set by the battery producer), this robot is now woken up and the discharging can start. A lengthy storage of the robot in this state (“woken up” i.e. not the deep sleep mode) can-as explained above-lead to a significantly discharged storage battery for the user. A conceivable alternative method for the end of line test in which the same storage battery, a so-called “production dummy”, is always (manually) installed in all assembled robots and then again (manually) dismantled and (also manually) replaced by a storage battery in low consumption state (deep sleep mode), is time-consuming and thus only of limited suitability for a production line.

The present disclosure of the invention describes an idea for reducing the discharge of the storage battery by setting a deep sleep mode of the storage battery built into the robot. The invention is based on the below described findings.

Storage batteries (or accumulators) or battery packs (battery modules) increasingly already have a battery management system (BMS) which is able to change into a sleep mode (sleep mode, low-power mode, hibernate mode, power-down mode, etc.; in this case always called the “deep sleep mode”). In this mode, the consumption of the BMS (and thus the “internal consumption” of the storage battery, i.e. the entire battery module, comprising the battery, the storage battery and the battery manager/the BMS) is reduced to a fraction of the normal values (not in deep sleep mode) by functions being switched off or reduced in the BMS. This includes, amongst other things, that the BMS only monitors the necessary values of the storage battery cells (for example voltage, temperature) and possibly only at certain time intervals (interval mode, for example the enquiry and evaluation of the voltage/temperature values only once a day).

A (deep) sleep mode not only serves for reduced consumption but also provides a safety function since in this mode the storage battery no longer outputs, or can no longer output, any significant power (output power of the battery module is limited) and thus the risk of short circuits or overloading (of the battery module and thus of the battery) is reduced.

Generally, to this end extra signal lines are provided on the storage battery (or the BMS thereof) by which a command (sleep signal) can be communicated to the BMS to change into sleep mode.

Changing back to operating mode or wake-up mode or power mode is implemented in different ways, either by a corresponding specific wake-up signal on a suitable signal line or, for example, by applying a voltage or a current (for example when charging up the storage battery) to the battery module (internal wake-up signal).

A storage battery built into a cleaning robot cannot easily change into a sleep mode or wake up therefrom, since a cooperation between the robot electronics system and the charging station has to be coordinated.

It might also be conceivable to measure the power consumption in the application, in this case a robot, and on the basis of not reaching a threshold value for the BMS then to disconnect the cells electrically from the application, resulting in no further discharge. In particular, the interpretation of the threshold values together with the tolerances is very difficult here. In particular, if the application knows the states/modes in which the power consumption is very low, for example if all storage batteries are switched off and only “connected” services (for example a Wi-Fi connection for control device applications) and/or a display are switched on, it can lead to a shut-down. Additionally, this embodiment can lead to an undesirable shut-down during the wake-up process, if only a small amount of current is taken at the start. Additionally, this embodiment has a requirement for current, which discharges the storage battery cells in addition to the application. This is all avoided by the invention.

The invention is based on the idea of activating the deep sleep mode of a battery module after installation in the robot, by a signal being triggered, in particular, manually by a user. This method is intended to ensure that the battery module neither inadvertently changes into sleep mode when the robot is in use by the user, nor that the battery module leaves the sleep mode when the robot is transported or stored.

As a solution, it is provided that the robot is designed as follows and thus, for example, the controller of the robot transmits a corresponding signal to the battery management system (BMS) of the battery module when a user presses either on the local user interface (control elements) on the robot, for example a specific combination of keys, or carries out a specific actuating sequence for some keys, or when a suitable button is pressed/confirmed in the app belonging to the robot (on an application running on a control device other than the robot). The BMS leaves the battery module in deep sleep mode until the robot is placed on its charging station and a charging process is started there. It is to be anticipated that a user initially carries out this step when setting up the robot after purchase, so that the robot is then available to the user in an unlimited manner. Nevertheless, an instruction in the manual of the robot can bring attention to the fact that the robot is only available after first being charged up. Such an instruction is, for example, an enclosed sheet of paper (“first step”) in the packaging of the robot, instructions in the operating manual, an instruction in the app at the start of the set-up of the robot, or a removable sticker in the vicinity of the main switch or the user interface of the robot; in each case with the instruction to place the robot as a first step onto the charging/base station, in order to terminate a storage battery-protective sleep mode and to permit the use thereof. Thus, for example, it is possible to avoid customer service complaints (“the robot does not work”) when the storage battery is in deep sleep.

A further advantage here is that the storage battery system is charged up for the first time after storage or transport and thus a full charge can be reliably used for determining or calibrating the state of charge. In particular, when the storage battery system implements a so-called “coulomb counter detection”, the current charging level or the stored charge is not accurately known due to the self-discharge and the operating current of the BMS during storage and transport. After the charging process, the state of charge can be adapted or taken as a new reference value.

After the robot has executed all functional tests of the end of line test (EoL), after its assembly in the course of production, the signal can be triggered by a production worker who presses the corresponding combination or sequence of keys, or transmits the signal by means of the connected mobile device and app, before the robot is packaged and dispatched. It is also conceivable that, in the case of a fully automated EoL test in an EoL automated system, the automated system itself carries out these steps, for example by a robot arm for actuating the keys, a cable connection or by means of a radio signal as an alternative to an app. The cleaning robot in this case is set into sleep mode after the quality control test has been successfully completed, so that the remaining charge in the battery module of the robot barely drops during storage and thus lengthy storage or transport distances are also permitted without falling below a critical lower limit.

A further application for a (deep) sleep mode of robots or a battery module are lengthy absences of the user (for example holiday or moving house) in which the user does not wish to use the robot or wishes to make sure that no incidents occur during their absence. In this case, the user can set the robot into deep sleep mode and later “wake-up” the robot equally via a local user interface (control elements) or by means of the app (signal receiver), by the robot being placed onto its charging station.

The combination or sequence of keys in this case can be selected, in particular, such that it cannot be actuated inadvertently. To this end, for example, in a first step the simultaneous pressing of specific keys (control elements) for a certain time period and then the (simultaneous or successive) pressing of other keys can be expedient. In other words, in particular, the keys of the user interface of the robot can be used in order to activate the sleep mode of the BMS in the storage battery by means of a combination of keys.

A corresponding button can be implemented in a very simple manner in an app on a mobile device belonging to the robot. Preferably, this button is in a subordinate settings menu in order to prevent inadvertent actuation. An activation of the (deep) sleep mode for the BMS of the robot storage battery is also possible, in particular, via an app control system.

For implementing the proposed function, a robot, for example a cleaning robot, can also have a local user interface with keys and/or a radio module for communication with an app on a mobile device, in particular in addition to a storage battery pack (battery module) with a BMS capable of deep sleep mode. Moreover, the robot can comprise, in particular, a controller, which can receive the command from the user and convert this into a command (wake-up/sleep signal) for the BMS of the battery module.

The battery module remains, in particular, in active operating mode until a voltage is applied to a switching circuit of the BMS. The BMS is also able to activate this switching circuit in (deep) sleep mode (for example if it wishes to carry out test routines on the storage battery cells or even in order to leave the sleep mode) (or an activation takes place when a corresponding signal which is powered by the internal energy of the battery is output from outside, but is not relevant in the present disclosure of the invention). If the battery module is set into sleep mode for transport or storage, the aforementioned power circuit is deactivated by a signal being transmitted from the robot controller to the BMS. The BMS then monitors only the necessary values of the storage battery cells and thus saves power. A reactivation takes place only when the robot is placed onto the charging station, so that a charging current flows into the storage battery cells, which the BMS registers and thus initiates the return to operating mode. The reactivation can also take place by the application of charging voltage. In this case, a flow of charging current is not absolutely necessary. Moreover, it should be added that in this operating state the energy supply for the BMS can be taken from the charging current of the charging device or the cells.

The construction of a suitable BMS for a storage battery-operated vacuuming robot, in particular, is made up as follows: the BMS substantially comprises a so-called “first stage protection”, a “second stage protection”, and a communication unit generally consisting of a microcontroller and a communication driver. As already mentioned above, in order to reduce the power consumption in the storage mode or deep sleep mode, it is expedient to shut down several, non-essential functions into deep sleep. However, it is advantageous not to deactivate all of the battery monitoring functions.

One possible and expedient variant could thus be as follows: after the deep sleep has been activated, the communication unit and the “first stage protection” are set into deep sleep. The “second stage protection” continues to remain activated with a very small operating current. A so-called “second stage protection” contains, for example, an overload protection and a temperature protection for the cells. A protection against insufficient voltage is thus not implemented, but no counter measure could be taken during the storage of the robot in any case. Rather, a monitoring of a critical voltage level, which is too low, has to be implemented in the context of a wake-up concept. Due to the extreme reduction in the power consumption in deep sleep mode to a few microamperes (only the “second stage protection” is active); a trouble-free storage period over a number of years can be assumed. This technical implementation or this example is particularly advantageous since the “first stage protection” and the communication unit have the highest operating power consumption in comparison with the “second stage protection” switching circuit. Thus, the functions which are not required and which at the same time have the highest power consumption are deactivated.

According to the invention, this results in the following advantages:

The power consumption of the BMS is reduced to an absolute minimum, so that a lengthy storage of the robot is made possible without risking damage to the storage battery cells.

The invention reduces the risk of inadvertent activation of the sleep mode (during use by the user). The robot or the BMS can only change into sleep mode by deliberate handling by the user (by input by means of a combination of keys or via the app).

The invention reduces the risk of an inadvertent deactivation of the sleep mode (during transport or storage). The robot or the BMS can only be reactivated by deliberate handling by the user (placing the robot on the charging/base station).

It is particularly advantageous if no energy is taken from the cells in order to start the wake-up process, since the energy is taken from the charging device (interface); in contrast to waking up via a key/switch on the robot, which would have to be powered by the battery. In particular, it has to be taken into account that a continuous discharge current could flow when the key is frequently or continually actuated deliberately (customer) or inadvertently (cardboard, packaging, transport).

Naturally, for example when not reaching a voltage threshold, the BMS can be set into deep sleep initiated by the robot itself, for example if the robot is not located on the charging station or the state of charge is too low in order to return to the station, or if the station is not connected to the mains network (unplugged, power outage).

The user can also deactivate the robot remotely by means of a command in the app, if required (if the robot is not currently located on the charging station (see below) which can also be easily achieved remotely, for example, via a Go-To command).

When implementing an automatic initialization of the deep sleep mode at the end of line automated system at the end of production, it is ensured that each robot is in transport mode. An inadvertent omission of this step (and dispatching the robot in the active state) can be eliminated.

If the robot is located on the charging station (energy is available at the interface) and a deep sleep mode is activated (sleep signal), the following solutions are conceivable: in the simplest case an immediate reactivation (wake-up signal) takes place, since in the currently activated sleep mode the BMS is immediately re-supplied with current. Naturally, it might be possible for the sleep mode to be able to be activated only when the storage battery is not currently being charged up. It is also conceivable that a circuit is installed for implementing a state machine, so that the BMS does not immediately react to the applied current, but only if this current had not been applied in the meantime and had only been applied again subsequently—the robot would then first have to be taken off the base station and replaced thereon in order to activate the robot. It is also conceivable that this is only triggered on the first pulse (docked, charging device connected, interface supplied with energy). This pulse is only provided when docking (or immediately thereafter). A continuous application of current/charging in each case triggers only one pulse. After a short dwell time in the undocked state, the pulse can be generated again. It is also conceivable that a software function identifies the “charging” state and does not transmit the request to shut down (sleep signal).

Other features which are considered as characteristic for the invention are set forth in the appended claims.

Although the invention is illustrated and described herein as embodied in a long-term storage of a robot containing a battery, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is an illustration showing a robot arrangement according to the invention; and

FIG. 2 is a flow diagram for a method for operating the robot of FIG. 1.

### DETAILED DESCRIPTION OF THE INVENTION

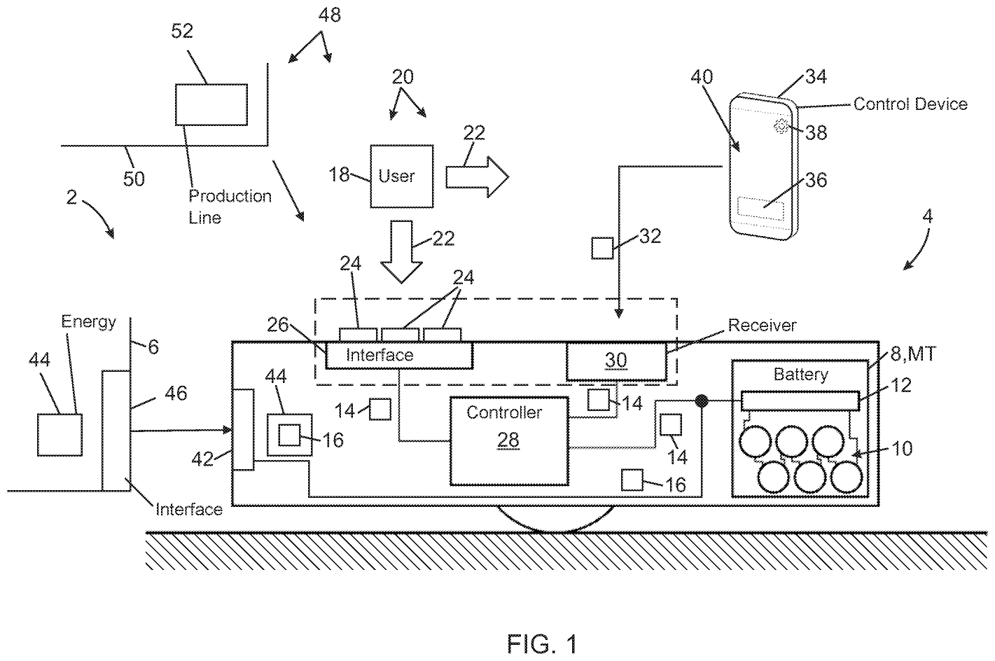

Referring now to the figures of the drawings in detail and first, particularly to FIG. 1 thereof, there is shown a robot arrangement 2. The robot arrangement contains a robot 4 and a charging station 6 for the robot 4. The robot 4 contains a battery module 8. The battery module 8 contains a rechargeable battery 10 and a battery manager 12. The battery 10 in this case is shown symbolically by six battery cells, not explained in more detail.

The battery manager 12 is configured to set the battery module 8 into a deep sleep mode MT upon receiving a sleep signal 14 and to terminate the deep sleep mode MT upon receiving a wake-up signal 16. The robot 4 is configured to generate the wake-up signal 16 without using energy from the battery 10. In a deep sleep mode MT the internal consumption of electrical energy of the battery manager 12 is significantly reduced compared to the non-deep sleep mode. As long as no electrical energy is supplied from outside to the robot 2, this energy requirement has to be met by the battery 10.

The robot 4 contains an input module 20, which can be controlled by a user 18. The robot 4 is configured to generate the sleep signal 14 when a sleep input 22 is executed on the input module 20. The sleep input 22 in this case is shown symbolically by an arrow and is an activity, which the user 18 executes in the example. The input module 20 contains three control elements 24, which can be manually actuated by the user 18, in this case in the form of keys as part of a user interface/an operating interface 26 on the robot 4. A specific actuation of the control elements 24, in particular by the user 18, represents a sleep input 22. To this end, the sleep input 22 requires the control elements 24 to be controlled according to a specific control pattern, in this case initially the two left-hand and then the two right-hand keys in FIG. 1 are pressed and released again within two seconds. The control pattern or the control or actuation of the control elements 24 according to the control or input pattern thus represents the sleep input 22. After pressing the corresponding keys, i.e. the successful sleep input 22, the sleep signal 14 is generated and communicated to the battery module 8 which thereupon changes to deep sleep mode MT. The evaluation of the actuation of the control elements 24, i.e. the monitoring of the sleep input 22, is carried out by a controller 28 of the robot 4, not explained in more detail herein.

The input module 20 also contains a signal receiver 30. This signal receiver is configured to receive an input signal 32, which can be generated by a user 18. The robot 4 is also configured to generate the sleep signal 14, when the input signal 32 is received by the signal receiver 30. The signal receiver 30 in this case is a wireless receiver and the input signal 32 is a wireless signal, in this case based on WLAN.

The signal receiver 30 is configured to receive the input signal 32 from a control device 34, which can be controlled by a user 18 with a further sleep input 22. The control device 34 is different from the robot 4. The control device 34 in this case is a hand-held control device, in the example a smartphone, carried by the user 18. The sleep input 22 is executed on the control device 34 by the user 18 actuating a function button 36 in the settings menu 38 (shown by a gearwheel) of an application 40 (in this case a smartphone app). The settings menu is a so-called set-up menu. In the application 40 the following text is displayed: “long term storage. Activate deep sleep mode for robot storage battery”. The function button 36 carries the label “activate”.

The sleep signal 14 is also finally generated in the robot 4 by means of this sleep input 22 and the battery module 8 is set into deep sleep mode MT.

The robot 2 contains an electrical interface 42. This electrical interface is designed to supply the battery module 8 with electrical energy 44, which is provided to the robot 4 from outside, i.e. from outside the robot 4, on the interface 42. The robot 4 is configured to generate the wake-up signal 16 when the interface 42 is supplied with electrical energy 44. The electrical energy for generating the wake-up signal 16 is provided in this case by the interface 42, thus is a part of the described energy 44 which otherwise serves for charging up/maintaining the charge of the battery module 8 or the battery 10. The charging station 6 has a counter-interface 46 for the interface 42. The counter-interface 46 serves for providing the electrical energy 44. The robot 4 is able to be coupled to the charging station 6 such that the interface 42 is supplied or can be supplied with the electrical energy 44 from the counter-interface 46. The wake-up signal 16 is thus generated without the use of electrical energy from the battery 10 since the electrical energy is part of the energy 44 from the counter-interface 46 or the interface 42.

In deep sleep mode MT, the battery manager 12 is configured to carry out simply a monitoring of a voltage and a temperature of the battery 10 at time intervals, preferably once a day.

FIG. 1 also shows symbolically a production facility 48 for a robot 4, in this case a factory of a manufacturer of the robot 2. This includes a production line 50 for robots 4, at the end thereof an end of line test 52 being carried out on the recently finished robot 4. At the end of the production of the robot 4 by means of the production line 50, the robot 4 or the battery module 8 thereof is set into deep sleep mode MT. This occurs within the end of line test or as the last step of the end of line test 52. Then the robot 4 is stored in the production facility 48 and subsequently dispatched to an end customer.

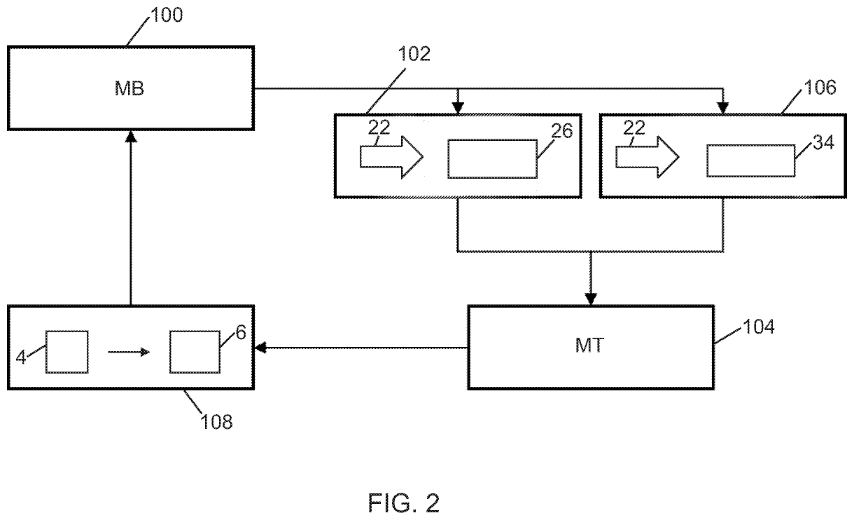

FIG. 2 shows in principle a sequence of changing between the operating mode MB (not the deep sleep mode MT) of the battery manager 12 and the deep sleep mode MT (with reduced self-discharge of the battery module 8). In a state 100 the battery manager 12 and thus the battery module 8 are in operating mode MB (not the deep sleep mode MT). In a step 102 the user executes a sleep input 22 on the user interface 26 (user interface of the robot 4), i.e. the user actuates a combination of keys of the control element 24. Thereupon the robot 2 changes into the state 104, namely the deep sleep mode MT. Alternatively, starting from the state 100, in a step 106 the user executes a sleep input 22 on the control device 34 by pressing the function button 36. Then the state 104 is present, i.e. the robot 4 changes into deep sleep mode MT.

In order to bring the robot 2 from the state 104 back into the state 100, the user couples the robot 4 to the charging station 6 so that the interface 42 is supplied with energy 44 from the counter-interface 46. In other words, the user ensures that the battery 10 is charged with energy 44. This triggers the wake-up signal 16 in the robot 4 and the robot returns into the operating mode MB, i.e. it leaves the deep sleep mode MT.

The following is a summary list of reference numerals and the corresponding structure used in the above description of the invention:
2 Robot arrangement
4 Robot
6 Charging station
8 Battery module
10 Battery
12 Battery manager
14 Sleep signal
16 Wake-up signal
18 User
20 Input module
22 Sleep input
24 Control element
26 Control interface
28 Controller
30 Signal receiver
32 Input signal
34 Control device
36 Function button
38 Settings menu
40 Application
42 (Electrical) interface
44 (Electrical) energy
46 Counter-interface
48 Production facility
50 Production line
52 End of line test
100 State
102 Step
104 State
106, 108 Step
MT Deep sleep mode
MB Operating mode

1. A robot, comprising:
a battery module having a battery and a battery manager managing said battery, wherein said battery manager is configured to set said battery module into a deep sleep mode upon receiving a sleep signal and to terminate the deep sleep mode upon receiving a wake-up signal, wherein the robot is configured to generate the wake-up signal without a use of energy from said battery.

2. The robot according to claim 1, further comprising an input module being controlled by a user, wherein the robot is configured to generate the sleep signal when a sleep input which can be executed by the user is made on said input module.

3. The robot according to claim 2, wherein said input module contains at least one control element which can be actuated by the user, wherein an actuation of said at least one control element is at least one component of the sleep input.

4. The robot according to claim 3, wherein said at least one control element is one of at least two control elements of said input module, said at least two control elements which can be actuated by the user and an actuation of a plurality of said control elements according to a specific control pattern is at least one component of the sleep input.

5. The robot according to claim 2, wherein said input module contains a signal receiver which is configured to receive an input signal which can be generated by the user, and the robot is configured to generate the sleep signal when the input signal is received.

6. The robot according to claim 5, wherein said signal receiver is a wireless receiver and the input signal is a wireless signal.

7. The robot according to claim 5, wherein said signal receiver is configured to receive the input signal from a control device which is different from the robot and which can be controlled by the user by means of the sleep input.

8. The robot according to claim 7, wherein said control device is a hand-held control device.

9. The robot according to claim 1,
further comprising an electrical interface configured to supply said battery module with electrical energy which is provided to the robot from outside on said electrical interface; and
wherein the robot is configured to generate the wake-up signal when said electrical interface is supplied with electrical energy.

10. The robot according to claim 9, wherein the electrical energy for generating the wake-up signal is provided from said electrical interface.

11. The robot according to claim 1, wherein in the deep sleep mode said battery manager is configured to carry out simply a monitoring of a voltage and/or a temperature of said battery at least at time intervals.

12. A robot configuration, comprising:
a robot containing an electrical interface and a battery module having a battery and a battery manager managing said battery, wherein said battery manager is configured to set said battery module into a deep sleep mode upon receiving a sleep signal and to terminate the deep sleep mode upon receiving a wake-up signal, wherein said robot is configured to generate the wake-up signal without a use of energy from said battery; and
a charging station for said robot and having a counter-interface for providing electrical energy, wherein said robot can be coupled to said charging station such that said electrical interface can be supplied with the electrical energy from said counter-interface.

13. A method for operating:
a robot containing an electrical interface and a battery module having a battery and a battery manager managing the battery, wherein the battery manager is configured to set the battery module into a deep sleep mode upon receiving a sleep signal and to terminate the deep sleep mode upon receiving a wake-up signal; or
a robot configuration according to claim 12;
wherein the method comprises the step of:
generating the wake-up signal without the use of energy from the battery.

14. The method according to claim 13, wherein the battery module is set into the deep sleep mode after or at an end of a production of the robot in a production facility and before a storage of the robot in the production facility and/or before a dispatch of the robot from the production facility.

15. The method according to claim 14, wherein the battery module is set into the deep sleep mode within an end of line test of the robot following the production of the robot or ending the production of the robot.
